(19) United States
(12) Patent Application Publication
(10) Pub. No.: US 2025/0185847 A1
(43) Pub. Date: Jun. 12, 2025

(54) Air Fryer with Oil Residual Prevention Arrangement

(71) Applicant: SHENZHEN CHENBEI TECHNOLOGY CO., LTD., SHENZHEN (CN)

(72) Inventor: Hai WEI, Shenzhen (CN)

(73) Assignee: SHENZHEN CHENBEI TECHNOLOGY CO., LTD., SHENZHEN, GD (CN)

(21) Appl. No.: 19/057,738

(22) Filed: Feb. 19, 2025

Related U.S. Application Data
(62) Division of application No. 17/020,785, filed on Sep. 14, 2020.

(30) Foreign Application Priority Data
Sep. 18, 2019 (CN) 201921556548.5

(51) Int. Cl. A47J 37/06; A47J 36/38; B01D 46/10; B01D 46/42; F24H 3/02

(52) U.S. Cl. CPC A47J 37/0641; A47J 36/38; B01D 46/10; B01D 46/4227; F24H 3/02

(57) ABSTRACT

An air fryer includes a first housing, a second housing, a heating element supported in the first housing, a fan supported in the first housing, and an oil residual prevention arrangement. The oil residual prevention arrangement includes a screening member detachably attached on at least one of the first housing and the second housing to provide a boundary between the first housing and the second housing such that oil residual produced from the second housing is substantially blocked by the screen member. The screening member has a plurality of ventilating channels communicating the first housing with the second housing so as to maintain sufficient air circulation between the first housing and the second housing for air frying.

### CROSS REFERENCE TO RELATED APPLICATIONS

This application is a divisional application of currently pending U.S. patent application Ser. No. 17/020,785, filed Sep. 14, 2020, which claims priority to Chinese patent application number CN 201921556548.9, filed on Sep. 18, 2019, the entire contents of which is hereby incorporated by reference.

### FIELD OF THE INVENTION

Embodiments of the present disclosure relates to an air fryer, and more particularly to an air fryer comprising an oil residual prevention arrangement which is capable of preventing oil residual or dirt from reaching a heating element of the air fryer.

### BACKGROUND

Air fryers have been widely utilized around the world for heating foods at elevated temperature. Air frying may resemble actual deep frying yet not requiring the use of extensive amount of oil. As a result, air frying has widely been perceived as a healthier alternative than traditional deep-fry cooking.

A conventional air fryer usually comprises a lower housing, an upper housing connected to the lower housing, a heating element and a fan accommodated in the upper housing. Food items may be supported in the lower housing. When the air fryer is operating, the heating element is arranged to heat up the air surrounding it. Heated air is then arranged to be circulated to the lower housing by the fan for heating up the food items.

A major disadvantage of conventional air fryers such as the one described above is that the heating element is positioned right above the compartment where the food items are positioned. As a result, when the air frying takes place, oil residue may, due to vigorous air flow and splashing actions, undesirably reach the upper housing and come into contact with the heating element. This problem will inevitably make cleaning of the heating element very inconvenient. When the heating element is not sufficiently cleaned, the general life span thereof will be shortened.

As a result, there is a need to develop an air fryer which may effectively prevent oil residues from reaching the heating element.

### SUMMARY

Implementations of the present disclosure provide an air fryer comprising an oil residual prevention arrangement which is capable of preventing oil residual or dirt from reaching a heating element of the air fryer.

In one aspect of the present disclosure, it provides an air fryer, comprising:
a first housing;
a second housing connected to the first housing;
at least one heating element supported in the first housing;
a fan supported in the first housing;
an oil residual prevention arrangement, which comprises a screening member detachably attached on at least one of the first housing and the second housing to provide a boundary between the first housing and the second housing such that oil residual produced from the second housing is substantially blocked by the screen member, the screening member having a plurality of ventilating channels communicating the first housing with the second housing so as to maintain sufficient air circulation between the first housing and the second housing for air frying.

This summary presented above is provided merely to introduce certain concepts and not to identify any key or essential features of the claimed subject matter.

### BRIEF DESCRIPTION OF THE DRAWINGS

FIG. I is a schematic diagram of an air fryer according to a preferred embodiment of the present invention.

FIG. 2 is a perspective view of a screening member of the air fryer according to the preferred embodiment of the present invention.

FIG. 3 is a partial sectional view of the screen member of the air fryer according to the preferred embodiment of the present invention.

FIG. 4 is a perspective view of the air fryer according to the preferred embodiment of the present invention.

FIG. 5 is a first alternative mode of the air fryer according to the preferred embodiment of the present invention.

FIG. 6 is an enlarged schematic diagram of a screening member of the air fryer according to a first alternative mode of the preferred embodiment of the present invention.

FIG. 7 is another enlarged schematic diagram of the screening member of the air fryer according to the first alternative mode of the preferred embodiment of the present invention.

FIG. 8 is an enlarged schematic diagram of a central portion of the screening member of the air fryer according to the first alternative mode of the preferred embodiment of the present invention.

FIG. 9 is a second alternative mode of the air fryer according to the preferred embodiment of the present invention.

FIG. 10 is a schematic diagram of a main screening frame of a screening member of the air fryer according to the second alternative mode of the preferred embodiment of the present invention.

### DETAILED DESCRIPTION OF THE PREFERRED EMBODIMENT

The following detailed description of the embodiments is the preferred mode of carrying out the present disclosure. The description is not to be taken in any limiting sense. It is presented for the purpose of illustrating the general principles of embodiments of the present disclosure.

It should be appreciated that the terms “install”, “connect”, “couple”, and “mount” in the following description refer to the connecting relationship in the accompanying drawings for easy understanding of embodiments of the present disclosure. For example, the connection can refer to permanent connection or detachable connection. Furthermore, “connected” may also mean direct connection or indirect connection, or connection through other auxiliary components. Therefore, the above terms should not be an actual connection limitation of the elements of embodiments of the present disclosure.

It should be appreciated that the terms “length”, “width”, “top”, “bottom”, “front”, “rear”, “left”, “right”, “vertical”, “horizontal”, “upper”, “lower”, “exterior”, and “interior” in the following description refer to the orientation or positioning relationship in the accompanying drawings for easy understanding of embodiments of the present disclosure without limiting the actual location or orientation of embodiments of the present disclosure. Therefore, the above terms should not be an actual location limitation of the elements of embodiments of the present disclosure.

It should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of embodiments of the present disclosure.

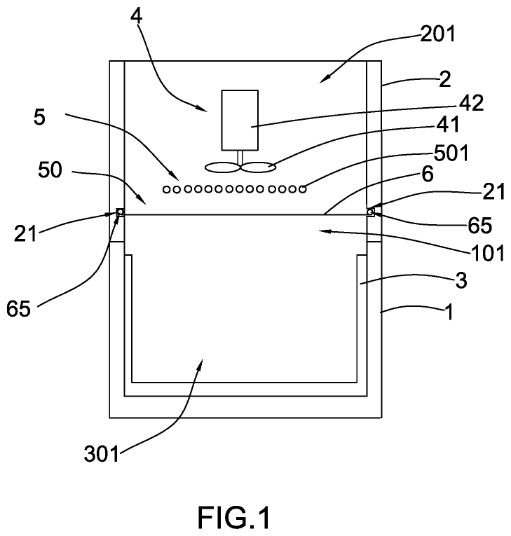

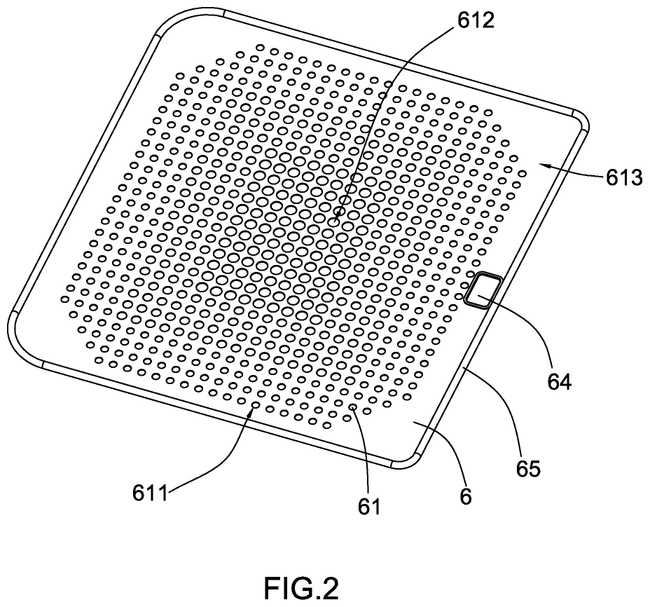

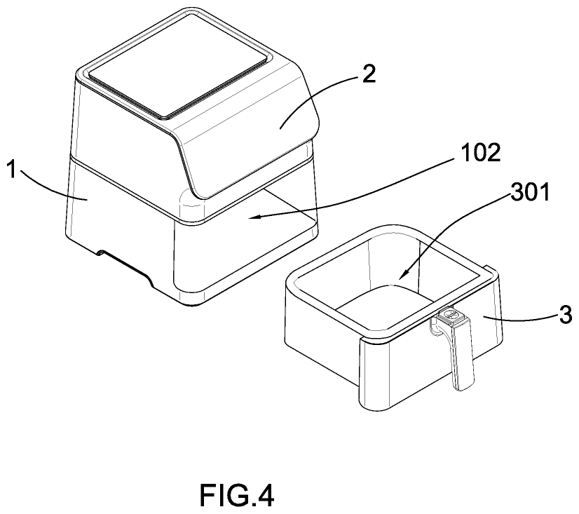

Referring to FIG. 1 to 4 of the drawings, an air fryer according to a preferred embodiment of the present invention is illustrated. Broadly, the air fryer may comprise a first housing 2, a second housing 1 connected to the first housing 2, at least one heating element 5 supported in the first housing 2, a fan 4 supported in the first housing 2, and an oil residual prevention arrangement 50.

The oil residual prevention arrangement 50 may comprise a screening member 6 detachably attached on at least one of the first housing 2 and the second housing 1 to provide a boundary between the first housing 2 and the second housing 1 such that oil residual produced from the second housing 1 is substantially blocked by the screen member 6. The screening member 6 may have a plurality of ventilating channels 61 communicating the first housing 2 with the second housing 1 so as to maintain sufficient air circulation between the first housing 2 and the second housing 1 for air frying.

According to the preferred embodiment of the present invention, the first housing 2 may have a first housing cavity 201, wherein the heating element 5 and the fan 4 may be supported in the first housing cavity 201. Control electronics may also be supported in the first housing cavity 201 for controlling an operation of the air fryer.

The second housing 1 may have a second housing cavity 101. The air fryer may further comprise a deep-frying tray 3 detachably attached on the second housing 1. The deep-frying tray 3 may have a food storage cavity 301 for temporarily accommodating a predetermined amount of food items. When the deep-frying tray 3 is attached on the second housing 1, the food storage cavity 301 may communicate with the second housing cavity 101, as shown in FIG. 1 of the drawings.

The second housing 1 may have an access opening 102 formed thereon, wherein the deep-frying tray 3 may be arranged to slidably insert through the access opening 102 for detachably attaching the deep-frying tray 3 on the second housing 1 in the manner described above.

In this preferred embodiment, the first housing 2 and the second housing 1 may be integrally connected with each other to form a one-piece structure in which the first housing 2 may be provided on top of the second housing 1. As a slight alternative, however, the first housing 2 and the second housing 1 may be separate structures which are connected with each other in a top-bottom manner.

The fan 4 may be accommodated in the first housing cavity 201. As shown in

FIG. 1 of the drawings, the fan 4 may comprise a plurality of fan blades 41 and a driving motor 42 connected to the fan blades 41 and arranged to drive the fan blades 42 to rotate. When the fan blades 41 are driven to rotate, air circulation between the first housing cavity 201 and the second housing cavity 101 is generated.

The heating element 5 may be arranged to generate heat in the first housing cavity 201. The heating element 5 may be supported in a vicinity of the fan blades 41 so that the heat generated by the heating element 5 may be carried away by the air circulation generated by the fan blades 41. In this preferred embodiment, the heating element 5 may comprise at least one heater tube 501 folded to form a manifold structure. The heating element 5 may be supported underneath the fan blades 41 so that when the fan blades 41 are driven to rotate, air circulation may tend to deliver heated air from the first housing cavity 201 downwardly toward the second housing cavity 101 and in particular the food storage cavity 301.

The screening member 6 of the oil residual prevention arrangement 50 may be provided at a position underneath the heating element 5. The screening member 6 may be detachably mounted on the first housing 2. As shown in FIG. 1 of the drawings, the driving motor 42, the fan blades 41, the heating element 5 and the screening member 6 may be sequentially arranged in the first housing 2 in a descending order so as to maximize the effectiveness of the screening member 6. In other words, the screening member 6 may effectively provide a physical barrier between the second housing cavity 101 and the first housing cavity 201 for blocking oil residual from reaching the first housing cavity 201. At the same time, the screening member 6 may also prevent a user's hand from accidentally touching the heating element 5.

The screening member 6 may have a plurality of through ventilating holes 611 for forming the ventilating channels 61 within the ventilating holes 611. The screening member 6 may be configured to have a panel structure and may have a central portion 612 and a peripheral portion 613. The air channels 61 may be formed both on the central portion 612 and the peripheral portion 613 of the screening member 6 in such a manner that more air is allowed to pass through the central portion 612 than that of the peripheral portion 613. Thus, the total air passage area formed on the central portion 612 may be larger than that of the peripheral portion 613. One way to accomplish this may be that a diameter of the ventilating holes 611 forming at the central portion 612 no less than that of the ventilating holes 611 forming at the peripheral portion 613 of the screening member 6. Moreover, a number of the through ventilating holes 611 forming at the central portion 612 may be no less than that of the ventilating holes 611 forming at the peripheral portion 613 of the screening member 6. The purpose of these construction is to ensure that heated air may be directed and concentrated to the food storage cavity 301 of the deep-frying tray 3. As a slight alternative, the ventilating holes 611 may be radially distributed on the screening member 6, and a diameter of each of the ventilating holes 611 may gradually decrease along a radial direction of the screening member 6.

More specifically, the heating element 5 may be provided right above the central portion 612 of the screening member 6 so that the heat generated by the heating element 5 may be effectively delivered to the food storage cavity 301 through the corresponding ventilating channels 61.

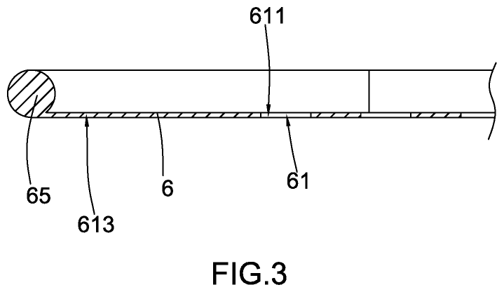

The oil residual prevention arrangement 50 may further comprise a plurality of sliding grooves 21 indently formed on two sidewalls of the first housing cavity 201, wherein two longitudinal side edge portions 65 may be arranged to slidably engage with the sliding grooves 21 so as to slidably mount the screening member 6 on the first housing 2. As shown in FIG. 3 of the drawings, the two longitudinal side edge portions 65 of the screening member 6 may have a substantially circular cross-sectional shape for slidably engaging with the sliding grooves 21 respectively.

The screening member 6 may further comprise a handle 64 formed on the peripheral portion 613 of the screening member 6 for allowing a user to grab thereon to slide the screening member 6 in or out from the first housing cavity 201. The handle 64 may be configured in the form of a protrusion or a slot for allowing a user of the present invention to hold onto it.

The operation of the present invention is as follows: a user may put food items in the deep-frying tray 3 and attach the deep-frying tray 3 in the second housing 1. After that, the user may turn on the air fryer and heat may be generated by the heating element 5. At the same time, the fan blades 41 may be driven to rotate by the driving motor 42. The heat generated by the heating element 5 may be circulated by the rotating fan blades 41 and eventually reach the food storage cavity 301 through the ventilating channels 61. On the other hand, oil residuals or other dirt materials emanating from frying the food items may be substantially blocked by the screening member 6 so as to prevent them from reaching the heating element 5. After deep frying, the screening member 6 may be slidably detached from the first housing 2 for further cleaning.

The advantages of the present invention are that by installing the screening member 6 between the first housing 2 and the second housing 1, oil residuals or other dirt materials emanating from frying food items may be substantially blocked by the screening member 6 while the air channels 61 may still provide sufficient air circulation between the heating element 5 and the food storage cavity 301.

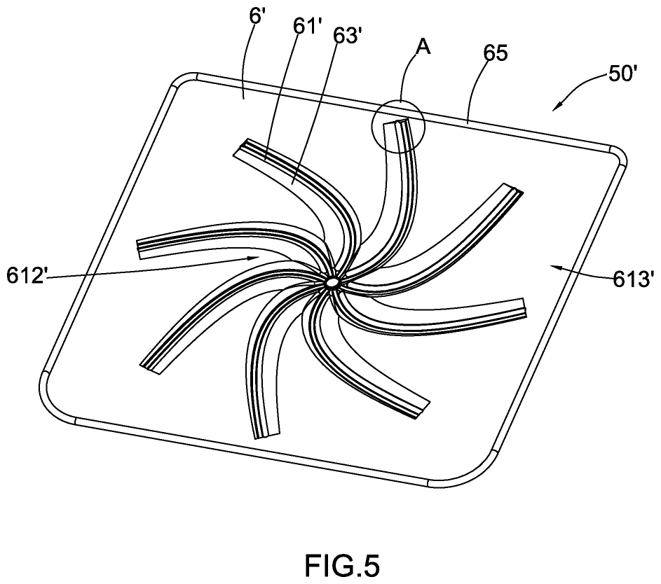

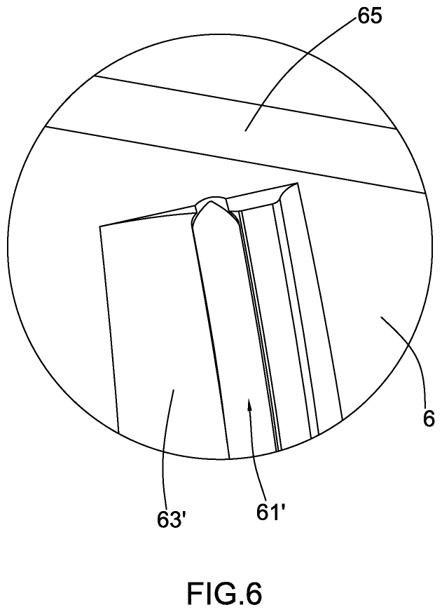

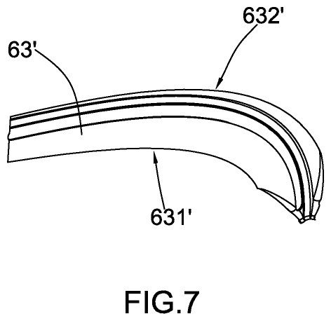

Referring to FIG. 5 to FIG. 8 of the drawings, a first alternative mode of the air fryer according to the preferred embodiment of the present invention is illustrated. The first alternative mode is similar to the preferred embodiment, except the screening member 6′ of the oil residual prevention arrangement 50′. According to the first alternative mode, the screening member 6′ may also be configured to have a panel structure and may have a central portion 612′ and a peripheral portion 613′. The air channels 61′ may be formed both on the central portion 612′ and the peripheral portion 613′ of the screening member 6′ in such a manner that more air is allowed to pass through the central portion 612′ than that of the peripheral portion 613′. Thus, the total air passage area formed on the central portion 612′ may be larger than that of the peripheral portion 613′.

Specifically, in this first alternative mode, the screening member 6′ may have a plurality of through ventilating slots 62′ forming the ventilating channels 61′. The ventilating slot 62′ may extend outwardly and radially from a central portion 615′ of the screening member 6′, wherein each of the ventilating slots 62′ may have two curved edges 621′ for forming a blade-like cross sectional shape of the ventilating slot 62′.

Note that in this first alternative mode, the screening member 6′ may further comprise a plurality of guiding members 63′ provided in the ventilating slots 62′ respectively for guiding air flow between the first housing 2 and the second housing 1′. Each of the guiding members 63′ may have a concavely curved surface 631′ facing the heating element 5, and a convexly curved surface 632′ facing the deep-frying tray 3. The guiding member 63′ is provided in the corresponding ventilating slot 62′ so as to guide the flow of air pass through the ventilating slot 62′. The overall contour of the ventilating slots 62′ and the guiding member 63′ may guide air circulated from the fan blades 41 to flow toward the deep-frying tray 3. Thus, the overall contour of the ventilating slots 62′ and the guiding member 63′ may form curved ventilating channels 61′. Moreover, the concavely curved shape of the concavely curved surface 631′ may also help to better collect residual oil from the deep-frying tray 3 and allow the residual oil to drip back to the deep-frying cavity 301.

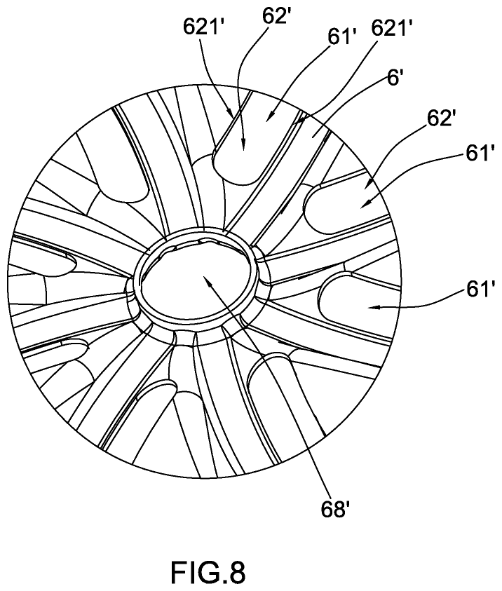

Referring to FIG. 8 of the drawings, the screening member 6′ may further have a central hole 68′ formed at a center of the screening member 6′, wherein the ventilating slots 62′ may outwardly and radially extend from the central hole 68′. One ventilating channel 61′ may also be formed in the space surrounded by the central hole 68′. The provision of the central hole 68′ allows direct vertical delivery of air from the fan blades 41 toward the deep-frying cavity 301.

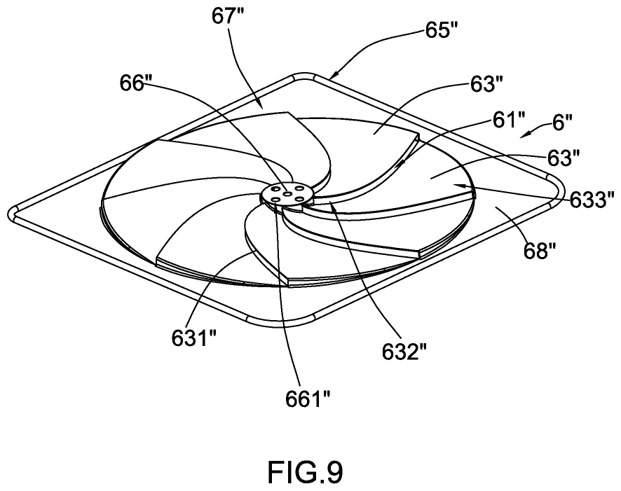

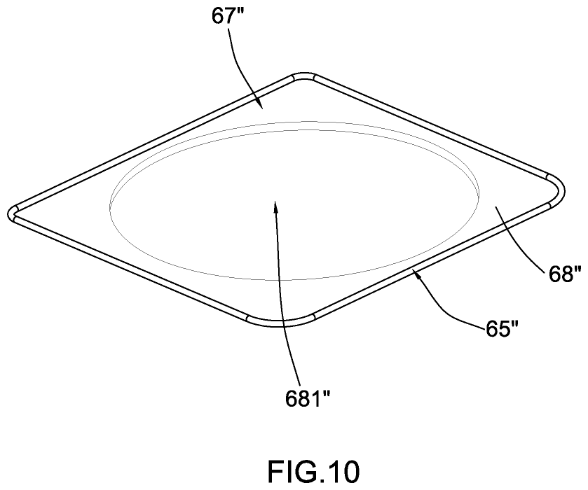

Referring to FIG. 9 and FIG. 10 of the drawings, a second alternative mode of the air fryer according to the preferred embodiment of the present invention is illustrated. The second alternative mode is similar to the preferred embodiment, except the screening member 6″ of the oil residual prevention arrangement 50″.

According to the second alternative mode, the screening member 6″ may comprise a main screening frame 68″ having a peripheral boundary rim 65″, a through central cavity 681″, and an extension portion 67″ extended between the peripheral boundary rim 65″ and the through central cavity 681″. Moreover, the screening member 6″ may further comprise a connecting member 66″ supported at the through central cavity 681″, and a plurality of guiding blades 63″ radially extended between the connecting member 66″ and the extension portion 67″ to form the ventilating channels 61″ as a space between each two adjacent guiding blades 63″.

Each of the guiding blades 63″ has an inner end portion 632″ connected to the connecting member 66″, and an outer end portion 633″ connected to the extension portion 67″ of the main screening frame 68″. Each of the guiding blades 63″ may have a curved cross-sectional shape when viewed from the side, and resemble a fan blade contour when viewed from the top. Each of the guiding blades 63″ may further have two guiding edges 631″ extended between the inner end portion 632″ and the outer end portion 633″. The two guiding edges 631″ of two adjacent guiding blades 63″ facing each other may have different vertical height so as to form the corresponding ventilating channel 61″ between each two adjacent guiding blades 63″. Each of the guiding edges 631″ may be curved in such a manner that a radius curvature of the guiding edge 631″ may gradually decrease from the inner end portion 632″ toward the outer end portion 633″ of the corresponding guiding blade 63″, so that a surface area of each of the guiding blades 63″ may gradually increase from the inner end portion 632″ toward the outer end portion 633″.

The provision of the guiding blades 63″ having the above-mentioned contour may allow air flowing from the first housing 2 to the second housing 1 to form a predetermined degree of vortex flow so as to allow more air to flow toward the deep-frying tray 3, better air circulation between the first housing 2 and the second housing 1, and to facilitate more effective air frying of the food items. The guiding blades 63″ may also help to block and collect oil residuals splashing from the deep-frying cavity 301. The oil residuals thus blocked and collected may eventually drip back down to the deep-frying cavity 301. The guiding blades 63″, the extension portion 67″ and the connecting member 66″ may be integrally connected to form a one-piece structure. This may facilitate easy manufacturing and cleaning of the screen member 6″.

Moreover, the connecting member 66″ may further have a plurality of through holes 661″ for allowing heated air to be directly delivered to a central portion of the second housing 1 so as to enhance air frying performance of the air fryer.

The screening members as described in the above preferred embodiment and its alternatives may be configured from durable and heat resistant material, such as metallic material, composite material or heat resistant plastic material.

Embodiments of the present disclosure, while illustrated and described in terms of disclosed embodiments and several alternatives, is not limited to the particular description contained in this specification. Additional alternative or equivalent components could also be used to practice embodiments of the present disclosure.

What is claimed is:

1. An air fryer apparatus having an oil residual prevention arrangement, the apparatus comprising:
a first housing;
a second housing connected to said first housing;
at least one heating element supported in said first housing;
a fan supported in said first housing;
an oil residual prevention arrangement comprising a substantially planar screening member removably installed on at least one of said first housing and said second housing;
wherein the planar screening member is configured to shield said first housing from said second housing, such that oil residual produced in said second housing is substantially blocked by said screening member from reaching said first housing;
wherein said screening member comprises a plurality of ventilating guides and a plurality of ventilating channels, each having a length disposed in the plane of the screening member;
wherein each of said plurality of ventilating guides is positioned adjacent each of said plurality of ventilating channels along said length; and
wherein each of said plurality of ventilating channels comprises a curved channel extending away from a central portion of said screening member, configured such that sufficient air circulation between said first housing and said second housing is maintained for air frying.

2. The apparatus of claim 1 wherein said first housing has a first housing cavity with said heating element and said fan supported therein, and said second housing has a second housing cavity with a deep-frying tray removably disposed therein, wherein said deep-frying tray comprises a food storage cavity.

3. The apparatus of claim 1 wherein said fan comprises a plurality of fan blades and a driving motor connected to said fan blades, arranged to rotate said fan blades to drive air circulation between said first housing cavity and said second housing cavity and through said screening member.

4. The apparatus of claim 3 wherein said heating element is supported underneath said fan blades such that when said fan blades rotate, air circulation delivers heated air from said first housing cavity downward into said second housing cavity.

5. The apparatus of claim 1 wherein said screening member is disposed underneath said heating element and is detachably mounted on said first housing.

6. The apparatus of claim 1 wherein said screening member further comprises a peripheral portion, wherein said ventilating channels are configured such that more air passes through said central portion than that of said peripheral portion.

7. The apparatus of claim 1 wherein said screening member further comprises a handle formed on said peripheral portion of said screening member for allowing a user to grab thereon to slide said screening member in and out from said first housing cavity.

8. The apparatus of claim 1 wherein said oil residual prevention arrangement further comprises a plurality of sliding grooves formed on two sidewalls of said first housing cavity, wherein two longitudinal side edge portions of said screening member are arranged to slidably engage with said sliding grooves respectively so as to slidably mount said screening member on said first housing.

9. The apparatus of claim 1 wherein each of said plurality of ventilating guides has a concavely shaped surface facing the second housing.

10. The apparatus of claim 1 wherein each of said plurality of ventilating guides has a convexly shaped surface facing the first housing.

11. The apparatus of claim 1 wherein the plurality of ventilating channels comprises a plurality of ventilating slots, each having two curved edges forming a blade-like cross-sectional shape.

12. The apparatus of claim 1 wherein said screening member further has a central hole formed at said central portion of said screening member, wherein said ventilating channels extend outwardly and radially from said central hole.

13. The apparatus of claim 1 wherein said heating element is disposed in sufficient proximity to said screening member such that a heat generated by said heating element is delivered to said second housing through said ventilating channels.

14. The apparatus of claim 1 wherein said screening member comprises a main screening frame having a peripheral boundary, a central cavity extending through said screening member, and an extension portion disposed between said peripheral boundary and said extension portion.

15. The apparatus of claim 14 further comprising a central connecting member, wherein said plurality of ventilating guides are configured as a plurality of guiding blades spanning the central cavity from the connecting member to the extension portion.

16. The apparatus of claim 15 wherein said plurality of ventilating channels each comprise a space disposed between each of the plurality of guiding blades.

17. The apparatus of claim 16 wherein each of said guiding blades has an inner end portion connected to said connecting member and an outer end portion connected to said extension portion, wherein each of said guiding blades comprises two guiding edges extending between said inner end portion and said outer end portion, and wherein adjacent guiding edges have a variable distance between them decreasing toward said outer end portion.

18. The air fryer, as recited in claim 17, wherein each of said guiding edges is curved such that a radius curvature of said guiding edge gradually decreases from said inner end portion toward said outer end portion of said corresponding guiding blade.

19. The air fryer, as recited in claim 18, wherein said connecting member further has a plurality of through holes for allowing heated air to be directly delivered to a central portion of said second housing.

20. An air fryer apparatus having an oil residual prevention arrangement, the apparatus comprising:
an oil residual prevention arrangement comprising a planar screening member disposed between a heating element and a food storage cavity;
wherein said screening member comprises a plurality of ventilating guides and a plurality of ventilating channels, each having a length, disposed in the plane of the screening member;
wherein each of said plurality of ventilating guides is positioned adjacent each of said plurality of ventilating channels along said length; and
wherein each of said plurality of ventilating channels comprises a curved channel extending away from a central portion of said screening member in the plane of said screening member, such that air moves through the ventilating channels from the heating element to the food storage cavity.
